(19) United States
(12) Patent Application Publication
(10) Pub. No.: US 2008/0026124 A1
(43) Pub. Date: Jan. 31, 2008

(54) Method for Producing Dry Powders of at Least One Carotenoid

(76) Inventors: Nina Musaeus, Hellerup (DK); Carsten Ninn Jensen, Ballerup (DK)

Correspondence Address: CONNOLLY BOVE LODGE & HUTZ, LLP, P O BOX 2207, WILMINGTON, DE, 19899, US

(21) Appl. No.: 11/663,410

(22) PCT Filed: Sep. 15, 2005
(86) PCT No.: PCT/EP05/09908

§ 371 Date: Mar. 21, 2007

(30) Foreign Application Priority Data
Sep. 21, 2004 (DE) 102004046026.4

(51) Int. Cl. C09B 61/00

(52) U.S. Cl. 426/540

(57) ABSTRACT

Processes for preparing dry, carotenoid-containing powders which are suitable for use as additives in foods, pharmaceuticals and animal feeds are described, which processes include: (a) providing a dispersion comprising one or more carotenoids in an aqueous molecular or colloidal solution comprising isomalt and at least one protective colloid; and (b) drying the dispersion to form a dry powder comprising the one or more carotenoids.

The invention relates to a process for producing dry powders of one or more carotenoids, in particular carotenoids selected from the group consisting of β-carotene, lutein, zeaxanthin, and lycopene or mixtures thereof.

The carotenoid class of substances is classified into two main groups, the carotenes and the xanthophylls. The carotenes, which are pure polyene hydrocarbons such as, for example, β-carotene or lycopene, differ from the xanthophylls which also have oxygen functionalities such as hydroxyl, epoxy and/or carbonyl groups. Typical representatives of the latter group are, inter alia, astaxanthin, canthaxanthin, lutein and zeaxanthin.

The oxygen-containing carotenoids also include citranaxanthin and ethyl β-apo-8′-cardtenoate.

Oxygen-containing carotenoids are widespread in nature and occur inter alia in corn (zeaxanthin), in green beans (lutein), in paprika (capsanthin), in egg yolk (lutein) and in shrimps and salmon (astaxanthin), conferring on these foodstuffs their characteristic color.

These polyenes, which can both be obtained by synthesis and be isolated from natural sources, represent important coloring materials and active substances for the human food and animal feed industries and for the pharmaceutical sector and are, as in the case of astaxanthin, active substances with provitamin A activity in salmon.

Both carotenes and xanthophylls are insoluble in water, while the solubility in fats and oils is found to be only low, however. This limited solubility and the great sensitivity to oxidation stand in the way of direct use of the relatively coarse-particled products obtained by chemical synthesis in the coloring of human foods and animal feeds because, in coarsely crystalline form, the substances are not stable during storage and provide only poor coloring results. These effects which are disadvantageous for use of carotenoids in practice are particularly evident in an aqueous medium.

Improved color yields in the direct coloring of human foods can be achieved only by specifically produced formulations in which the active substances are in finely divided form and, if appropriate, protected from oxidation by protective colloids. In addition, use of these formulations in animal feeds leads to a greater bioavailability of the carotenoids or xanthophylls and thus indirectly to improved coloring effects, for example in egg yolk or fish pigmentation.

Various processes have been described for improving the color yields and for increasing the absorbability or bioavailability and all of them aim at reducing the size of the crystallites of the active substances and bringing the particles to a size in the region below 10 μm.

Numerous methods, inter alia described in Chimia 21, 329 (1967), WO 91/06292 and WO 94/19411, involve the grinding of carotenoids using a colloid mill and thus achieve particle sizes of from 2 to 10 μm.

There also exist a number of combined emulsification/spray drying processes as described, for example, in DE-A-12 11 911 or in EP-A-0 410 236.

According to European patent EP-B-0 065 193, carotenoid products in finely divided powder form are produced by dissolving a carotenoid in a volatile, water-miscible organic solvent at elevated temperatures, if appropriate under elevated pressure, and precipitating the carotenoid by mixing with an aqueous solution of a protective colloid and then spray drying.

An analogous process for producing carotenoid products in finely divided powder form is described in EP-A-0 937 412 with use of water-immiscible solvents.

DE-A-44 24 085 describes the use of partly degraded soybean proteins as protective colloids for fat-soluble active substances. The soybean proteins disclosed herein have a degree of degradation of from 0.1 to 5%.

German published specification DE-A-101 04 494 describes the production of carotenoid dry powders by using soybean proteins together with lactose as protective colloids.

Despite the carotenoid formulations which have already been numerously described in the prior art mentioned at the outset, there is still a need for improvements in these preparations, whether in relation to a better stability on storage, an increased bioavailability or a better solubility/redispersibility in aqueous systems, for example in beverages.

It was therefore an object of the present invention to propose processes for producing carotenoid-containing dry powders which satisfy the abovementioned requirements.

This object has been achieved according to the invention by a process for producing dry powders of one or more carotenoids, which comprises
a) dispersing one or more carotenoids in an aqueous molecular or colloidal solution of a mixture of isomalt and at least one protective colloid and
b) converting the dispersion which has formed into a dry powder by removing the water and, if appropriate, additionally used solvents and subsequently drying, if appropriate in the presence of a coating material.

Suitable carotenoids in the context of the present invention are inter alia α- and β-carotene, lycopene, lutein, astaxanthin, zeaxanthin, capsanthin, capsorubin, α- and β-cryptoxanthin, citranaxanthin, canthaxanthin, bixin, β-apo-4-carotenal, β-apo-8-carotenal and β-apo-8-carotenoic esters or mixtures thereof. Preferred carotenoids are β-carotene, β-cryptoxanthin, lycopene, lutein, astaxanthin, zeaxanthin and canthaxanthin. Carotenoids selected from the group consisting of β-carotene, lutein, zeaxanthin and lycopene or mixtures thereof are particularly preferred, and β-carotene, lycopene and lutein or mixtures thereof, especially β-carotene, are very particularly preferred.

The designation isomalt stands for a sugar substitute which is also available under the brand name Palatinit® (from Südzucker, Germany). Isomalt is a hydrogenated isomaltulose which consists of approximately equal parts of 6-O-α-D-glucopyranosyl-D-sorbitol and 1-O-α-D-glucopyranosyl-D-mannitol.

A dispersion means in the context of the present invention both emulsions and suspension, preferably suspensions.

Examples of suitable protective colloids are the following substances: bovine, porcine or fish gelatin, in particular acid- or base-degraded gelatin having Bloom numbers in the range from 0 to 250, very particularly preferably gelatin A 100, A 200, A 240, B 100 and B 200, and low molecular weight, enzymatically degraded gelatin types having the Bloom number 0 and molecular weights of from 15 000 to 25 000 D, such as, for example, Collagel A and Gelitasol P (from Stoess, Eberbach) and mixtures of these gelatin types.

Starch, modified starch, dextrin, pectin, gum arabic, ligninsulfonates, chitosan, polystyrenesulfonate, alginates, caseine, caseinate, methylcellulose, carboxymethylcellulose, hydroxypropylcellulose or mixtures of these protective colloids.

Vegetable proteins such as soybean, rice and/or wheat proteins, it being possible for these vegetable proteins to be in partially degraded or in undegraded form.

Preferred protective colloids used in the context of the present invention are modified starch, in particular octenylsuccinate-starch.

A preferred embodiment of the abovementioned process comprises grinding a suspension produced in process step a) before conversion into a dry powder. In this case, the active substance [the carotenoid(s)] is preferably suspended in crystalline form in the abovementioned protective colloid solution before the grinding process.

The grinding can take place in a manner known per se, for example using a ball mill. This entails, depending on the type of mill used, grinding until the particles have an average particle size D[4.3] determined by Fraunhofer diffraction of from 0.02 to 100 μm, preferably 0.05 to 50 μm, particularly preferably 0.05 to 20 μm, very particularly preferably 0.05 to 5 μm, especially 0.05 to 0.8 μm. The term D[4.3] refers to the volume-weighted average diameter (see Handbook for Malvern Mastersizer S, Malvern Instruments Ltd., UK).

Further details of the grinding and the apparatus employed therefor are to be found, inter alia, in Ullmann's Encyclopedia of Industrial Chemistry, Sixth Edition, 2000, Electronic Release, Size Reduction, Chapter 3.6.: Wet Grinding, and in EP-A-0 498 824.

The grinding of the carotenoid crystals in the aqueous protective colloid solution can moreover take place both in the presence and in the absence of isomalt.

A further preferred embodiment of the invention is therefore also a process for producing a dry powder comprising carotenoids selected from the group consisting of β-carotene, lutein, zeaxanthin and lycopene or mixtures thereof, which comprises
a) suspending β-carotene, lutein, zeaxanthin or lycopene or mixtures thereof in an aqueous molecular or colloidal solution of a mixture of isomalt with modified starch,
b) grinding the suspended particles and
c) converting the suspension subsequently into a dry powder.

A further preferred aspect of the invention is likewise a process for producing a dry powder comprising carotenoids selected from the group consisting of β-carotene, lutein, zeaxanthin and lycopene or mixtures thereof, which comprises
a) suspending β-carotene, lutein, zeaxanthin or lycopene or mixtures thereof in an aqueous molecular or colloidal solution of modified starch,
b₁) grinding the suspended particles,
b₂) mixing the ground suspension with isomalt and
c) converting the suspension subsequently into a dry powder.

A likewise preferred variant of the process of the invention is one wherein the suspending in stage a) comprises the following steps:
a₁) dissolving one or more carotenoids in a water-miscible organic solvent or in a mixture of water and a water-miscible organic solvent or
a₂) dissolving one or more carotenoids in a water-immiscible organic solvent and
a₃) mixing the solution obtained as in a₁) or a₂) with an aqueous molecular or colloidal solution of a mixture of isomalt and at least one protective colloid, resulting in the hydrophobic phase of the carotenoid as nanodisperse phase.

The water-miscible solvents used in stage a₁) are, in particular, water-miscible, thermally stable, volatile solvents comprising only carbon, hydrogen and oxygen, such as alcohols, ethers, esters, ketones and acetals. The solvents expediently used are those which are at least 10% water-miscible, have a boiling point below 200° C. and/or have fewer than 10 carbons. Those particularly preferably used are methanol, ethanol, n-propanol, isopropanol, 1,2-butanediol 1-methyl ether, 1,2-propanediol 1-n-propyl ether, tetrahydrofuran or acetone. The term “a water-immiscible organic solvent” means for the purpose of the present invention an organic solvent with a solubility in water of less than 10% under atmospheric pressure. Possible solvents in this connection are, inter alia, halogenated aliphatic hydrocarbons such as, for example, methylene chloride, chloroform and tetrachloromethane, carboxylic esters such as dimethyl carbonate, diethyl carbonate, propylene carbonate, ethyl formate, methyl, ethyl or isopropyl acetate and ethers such as methyl tert-butyl ether. Preferred water-immiscible organic solvents are the following compounds from the group consisting of dimethyl carbonate, propylene carbonate, ethyl formate, ethyl acetate, isopropyl acetate and methyl tert-butyl ether.

The process of the invention preferably involves the production of dry powders of one or more carotenoids selected from the group consisting of β-carotene, lutein, zeaxanthin or lycopene or mixtures thereof.

The abovementioned dry powders are advantageously produced in such a way that at least one of the carotenoids is dissolved in a water-miscible organic solvent at temperatures above 30° C., preferably between 50° C. and 240° C., in particular 100° C. to 200° C., particularly preferably 140° C. to 180° C., if appropriate under pressure.

Since exposure to high temperatures may in some circumstances reduce the desired high proportion of all-trans isomer, the dissolving of the carotenoid(s) takes place as quickly as possible, for example in the region of seconds, e.g. in 0.1 to 10 seconds, particularly preferably in less than 1 second. For rapid preparation of the molecular solution it may be advantageous to apply elevated pressure, e.g. in the range from 20 bar to 80 bar, preferably 30 to 60 bar.

To the molecular solution obtained in this way is subsequently added directly the aqueous molecular or colloidal solution, which is cooled if appropriate, of the mixture of isomalt and at least one protective colloid in such a way that a mixing temperature of about 35° C. to 80° C. is set up.

During this, the solvent component is transferred into the aqueous phase, and the hydrophobic phase of the carotenoid(s) results as nanodisperse phase.

Reference is made at this point to EP-B-0 065 193 for a detailed description of the process and apparatus for the abovementioned dispersion.

The invention likewise relates to a process for producing a dry powder comprising carotenoids selected from the group consisting of β-carotene, lutein, zeaxanthin and lycopene or mixtures thereof, which comprises
a) dissolving β-carotene, lutein, zeaxanthin or lycopene or mixtures thereof in a water-miscible organic solvent or a mixture of water and a water-miscible organic solvent at temperatures above 30° C.,
b) mixing the resulting solution with an aqueous molecular or colloidal solution of a mixture of isomalt with modified starch, in particular with octenylsuccinate-starch, and
c) converting the suspension which has formed into a dry powder.

A process for producing β-carotene-containing dry powders using a mixture of isomalt and modified starch, in particular of isomalt and octenylsuccinate-starch, is very particularly preferred in this connection.

The conversion into a dry powder can take place inter alia by spray drying, spray cooling, modified spray drying, freeze drying or drying in a fluidized bed, if appropriate also in the presence of a coating material. Suitable coating agents are, inter alia, corn starch, silica or else tricalcium phosphate.

Further details on spray cooling and on modified spray drying are to be found in WO 91/06292 (pages 5 to 8).

To increase the stability of the active substance it is advantageous to add stabilizers such as α-tocopherol, t-butylhydroxytoluene, t-butylhydroxyanisole, citric acid, sodium citrate, ascorbic acid, sodium ascorbate, ascorbyl palmitate or ethoxyquin or mixtures thereof in a concentration of from 0.05 to 10% by weight, preferably 0.1 to 7% by weight, based on the dry mass of the powder. They can be added either to the aqueous or to the solvent phase.

To increase the stability of the active substance to microbial degradation, it may be expedient to add preservatives such as, for example, methyl 4-hydroxybenzoate, propyl 4-hydroxybenzoate, sorbic acid or benzoic acid or their salts to the preparation.

It may also be advantageous in some circumstances additionally for a physiologically acceptable oil such as, for example, sesame oil, corn oil, cottonseed oil, soybean oil or peanut oil, and esters of medium chain-length vegetable fatty acids, in a concentration of from 0 to 500% by weight, preferably 10 to 300% by weight, particularly preferably 20 to 100% by weight, based on the carotenoid(s), to be dissolved in the solvent phase and then precipitated as extremely fine particles together with the active substances and said additives on mixing with the aqueous phase.

The ratio of protective colloid and isomalt to carotenoid is generally chosen so that the resulting final product comprises from 0.1 to 40% by weight, preferably 1 to 35% by weight, particularly preferably 5 to 25% by weight of at least one carotenoid, 1 to 50% by weight, preferably 5 to 40% by weight, particularly preferably 10 to 35% by weight of at least one protective colloid and 10 to 80% by weight, preferably 15 to 75% by weight, particularly preferably 20 to 60% by weight of isomalt, all percentages based on the dry mass of the powder, and, if appropriate, small amounts of stabilizers and preservatives.

The invention also relates to dry powders of carotenoids obtainable by one of the processes mentioned at the outset.

These are preferably dry powders comprising carotenoids selected from the group consisting of astaxanthin, canthazanthin, β-carotene, lutein, zeaxanthin, β-cryptoxanthin and lycopene, particularly preferably dry powders comprising a mixture of β-carotene, lutein, zeaxanthin and lycopene, very particularly preferably a β-carotene, lutein and lycopene-containing dry powder, in particular a β-carotene dry powder.

The dry powders of the invention are distinguished inter alia by the fact that they can be redispersed without problems in aqueous systems to result in a uniform fine distribution of the active substance in the particle size range below 1 μm.

The use of a combination of isomalt and protective colloids, in particular modified starch, as formulation excipients has the advantage compared with other sugars, for example lactose or sucrose, that the carotenoid formulations produced therewith show a particularly high storage stability inter alia in multivitamin tablets (see Table).

The carotenoid formulations of the invention are suitable inter alia as additive to food preparations, in particular for coloring food products such as beverages, as means for producing pharmaceutical and cosmetic preparations, and for the production of dietary supplement products, for example of multivitamin products in the human and animal sectors.

The procedure for the process of the invention is explained in detail in the following examples.

### EXAMPLE 1

Production of a β-carotene dry powder using a mixture of isomalt and octenylsuccinate-starch

a. Under protective gas, 19.5 l of water were heated to 55° C., and 0.44 kg of sodium ascorbate, 0.39 kg of ascorbic acid and 8.33 kg of octenylsuccinate-starch (Capsul®, from National Starch) were added. 8.33 kg of crystalline β-carotene were suspended in this solution while stirring. The suspension was then ground with the aid of a ball mill until the β-carotene particles had an average particle size D[4.3], ascertained by Fraunhofer diffraction, of less than 0.8 μm.

b. 2.93 kg of this ground suspension were transferred under protective gas into a second reactor and, while stirring, 0.75 kg of isomalt and a further 0.456 kg of octenylsuccinate-starch were added. The temperature of this mixture was kept at 55° C. After addition of 0.0335 kg of α-tocopherol, the suspension was homogenized and then converted by modified spray drying into a dry powder in the form of beadlets. The β-carotene content in the beadlets was 21.0% with an E1/1 ¹⁾ of 85.
¹⁾ The E1/1 defines in this connection the specific extinction of a 0.5% strength aqueous dispersion of a 20% by weight dry powder in a 1 cm cuvette at the absorption maximum.

### EXAMPLE 2

Production of a β-carotene dry powder using a mixture of isomalt and octenylsuccinate-starch

Under protective gas, 1.97 of water are heated to 55° C., and 26.5 g of sodium ascorbate, 23.5 g of ascorbic acid, 564 g of isomalt and 500 g of octenylsuccinate-starch (Capsul®, from National Starch) are added. 500 g of crystalline β-carotene are suspended in this solution while stirring, and the suspension is ground with the aid of a ball mill until the β-carotene particles have an average particle size D[4.3], ascertained by Fraunhofer diffraction, of less than 0.8 μm.

Then a further 340.7 g of octenylsuccinate-starch are dissolved in the suspension. After addition of 25 g of α-tocopherol, the suspension is homogenized and converted by modified spray drying into a dry powder in the form of beadlets. The β-carotene content in the beadlets is 20%.

### EXAMPLE 3

Production of a dry powder comprising β-carotene, lutein and lycopene using a mixture of isomalt and octenylsuccinate-starch

Under protective gas, 2.4 l of water are heated to 55° C., and 26.5 g of sodium ascorbate, 23.5 g of ascorbic acid, 564 g of isomalt and 500 g of octenylsuccinate-starch (Capsul®, from National Starch) are added. 167 g of crystalline β-carotene, 167 g of crystalline lycopene and 167 g of crystalline lutein are suspended in this solution while stirring, and the suspension is ground with the aid of a ball mill until the carotenoid particles have an average particle size D[4.3], ascertained by Fraunhofer diffraction, of less than 0.8 μm.

A further 1420 g of octenylsuccinate-starch and 715 g of isomalt are dissolved in the ground suspension. After addition of 25 g of α-tocopherol, the suspension is homogenized and then converted by modified spray drying into a dry powder in the form of beadlets. The total carotenoid content in the beadlets is 10% with a β-carotene:lutein:lycopene ratio of 1:1:1.

### EXAMPLE 4 (COMPARATIVE EXPERIMENT)

Production of a β-carotene dry powder using a mixture of trehalose and octenylsuccinate-starch

3.11 kg of the ground suspension from Example 1a were transferred under protective gas into a second reactor and, while stirring, 0.8 kg of trehalose and a further 0.456 kg of octenylsuccinate-starch were added. The temperature of this mixture was kept at 55° C. After addition of 0.036 kg of α-tocopherol, the suspension was homogenized and then converted by modified spray drying into a dry powder in the form of beadlets. The β-carotene content in the beadlets was 23.6% with an E1/1 ¹⁾ of 84.

### EXAMPLE 5 (COMPARATIVE EXPERIMENT)

Production of a β-carotene dry powder using a mixture of mannitol and octenylsuccinate-starch

3.32 kg of the ground suspension from Example 1a were transferred under protective gas into a second reactor and, while stirring, 0.85 kg of mannitol and a further 0.517 kg of octenylsuccinate-starch were added. The temperature of this mixture was kept at 55° C. After addition of 0.038 kg of α-tocopherol, the suspension was homogenized and then converted by modified spray drying into a dry powder in the form of beadlets. The β-carotene content in the beadlets was 21.7% with an E1/1 ¹⁾ of 78.

### EXAMPLE 6 (COMPARATIVE EXPERIMENT)

Production of a β-carotene dry powder using a mixture of sucrose and octenylsuccinate-starch

2.56 kg of the ground suspension from Example 1a were transferred under protective gas into a second reactor and, while stirring, 0.66 kg of sucrose and a further 0.4 kg of octenylsuccinate-starch were added. The temperature of this mixture was kept at 55° C. After addition of 0.030 kg of α-tocopherol, the suspension was homogenized and then converted by modified spray drying into a dry powder in the form of beadlets. The β-carotene content in the beadlets was 21.6% with an E1/1 ¹⁾ of 89.

### EXAMPLE 7 (COMPARATIVE EXPERIMENT)

Production of a β-carotene dry powder using octenylsuccinate-starch

2.82 kg of the ground suspension from Example 1a were transferred under protective gas into a second reactor and, while stirring, a further 1.15 kg of octenylsuccinate-starch were added. The temperature of this mixture was kept at 55° C. After addition of 0.030 kg of α-tocopherol, the suspension was homogenized and then converted by modified spray drying into a dry powder in the form of beadlets. The β-carotene content in the beadlets was 23.1% with an E1/1 ¹⁾ of 90.

### EXAMPLE 8

Production of a β-carotene dry powder using a mixture of isomalt and sodium caseinate

62 g of crystalline β-carotene, 20 g of α-tocopherol and 5 g of ascorbyl palmitate were suspended in 430 g of an azeotropic isopropanol/water mixture at room temperature in a heatable receiver. The active substance suspension was then heated to 90° C. and continuously mixed at a flow rate of 2.9 kg/h with further isopropanol/water azeotrope of temperature 220° C. and a flow rate of 4.5 kg/h, whereupon β-carotene dissolved at a mixing temperature of 175° C. which was set up under a pressure of 55 bar. This active substance solution was then directly mixed with an aqueous phase consisting of a solution of 75 g of sodium caseinate, 290.5 g of isomalt and 10 g of preservative in 8325 g of distilled water, in which the pH was adjusted to pH 9.5 with 1 M NaOH, at a flow rate of 50 kg/h.

The active substance particles resulting in the mixture had in the isopropanol/water mixture a particle size of 180 nm with an E1/1 ¹⁾ of 117.

The active substance suspension was then concentrated in a thin-film evaporator to a concentration of about 30% by weight dry matter and spray dried. The dry powder had a β-carotene content of 13.2% by weight. The dry powder redispersed in water had a particle size of 190 nm and an E1/1 of 116.

### EXAMPLE 9

Production of a β-carotene dry powder using a mixture of isomalt and octenylsuccinate-starch

62 g of crystalline β-carotene and 19 g of α-tocopherol were suspended in 430 g of an azeotropic isopropanol/water mixture at room temperature in a heatable receiver. The active substance suspension was then heated to 90° C. and continuously mixed at a flow rate of 2.9 kg/h with further isopropanol/water azeotrope of temperature 220° C. and a flow rate of 4.5 kg/h, whereupon β-carotene dissolved at a mixing temperature of 175° C. which was set up under a pressure of 55 bar. This active substance solution was then directly mixed with an aqueous phase consisting of a solution of 160 g of Capsul, 220.5 g of isomalt and 10 g of preservative in 8325 g of distilled water at a flow rate of 50 kg/h.

The active substance particles resulting in the mixture had in the isopropanol/water mixture a particle size of 250 nm with an E1/1 ¹⁾ of 95.

The active substance suspension was then concentrated in a thin-film evaporator to a concentration of about 35% by weight dry matter and spray dried. The dry powder had a β-carotene content of 13.0% by weight. The dry powder redispersed in water had a particle size of 252 nm and an E1/1 of 93.

Table: Storage stability of the β-carotene beadlets in multivitamin tablets

The stability of the

-carotene beadlets was tested by means of multivitamin mineral tablets having a content of about 3 mg of β-carotene per tablet. The tablets were packaged in HDPE containers whose lid was sealed with heat-sealed aluminum foil. The tablets were stored at 40° C. and 75% relative humidity for 6 months. The β-carotene content was analyzed in each case after storage for 3 and 6 months.

TABLE

| | | | | t = 0 months | After 3 months | | After 6 months | |
|---|---|---|---|---|---|---|---|---|
| | | | | Content of β- | Content of β- | | Content of β- | |
| | | | Content: | carotene per | carotene per | Loss | carotene per | Loss |
| Ex. | Sugar | Colloid | β-carotene | tablet [mg] | tablet [mg] | (%) | tablet [mg] | (%) |
| 1 | Isomalt | Capsul | 21.0 | 3.40 | 2.77 | 18.5 | 2.68 | 21.2 |
| 4 | Trehalose | Capsul | 23.6 | 3.77 | 2.72 | 27.9 | 2.59 | 31.3 |
| 5 | Mannitol | Capsul | 21.7 | 3.46 | 2.11 | 39.0 | 2.12 | 38.7 |
| 6 | Sucrose | Capsul | 21.6 | 3.39 | 2.57 | 24.2 | 2.45 | 27.7 |
| 7 | — | Capsul | 23.1 | 3.63 | 2.42 | 33.3 | | |

1-14. (canceled)

15. A process comprising:
(a) providing a dispersion comprising one or more carotenoids in an aqueous molecular or colloidal solution comprising isomalt and at least one protective colloid; and
(b) drying the dispersion to form a dry powder comprising the one or more carotenoids.

16. The process according to claim 15, further comprising grinding the dispersion before drying.

17. The process according to claim 15, wherein the dispersion comprises a suspension.

18. The process according to claim 17, further comprising grinding the suspension before drying.

19. The process according to claim 17, wherein providing the suspension comprises: (i) dissolving the one or more carotenoids in a solvent selected from water-miscible organic solvents, water-immiscible organic solvents, and aqueous mixtures thereof, to form a carotenoid solution; and (ii) mixing the carotenoid solution with the aqueous molecular or colloidal solution to form the suspension.

20. The process according to claim 15, wherein the at least one protective colloid comprises a modified starch.

21. The process according to claim 15, wherein the at least one protective colloid comprises octenylsuccinate-starch.

22. The process according to claim 15, wherein the one or more carotenoids comprises a compound selected from the group consisting of β-carotene, lutein, zeaxanthin, lycopene, and mixtures thereof.

23. The process according to claim 18, wherein the one or more carotenoids comprises a compound selected from the group consisting of β-carotene, lutein, zeaxanthin, lycopene, and mixtures thereof.

24. The process according to claim 23, wherein the at least one protective colloid comprises a modified starch.

25. The process according to claim 17, wherein the one or more carotenoids comprises a compound selected from the group consisting of β-carotene, lutein, zeaxanthin, lycopene, and mixtures thereof; wherein the at least one protective colloid comprises a modified starch; and wherein providing the suspension comprises: (i) dissolving the one or more carotenoids in a solvent selected from the group consisting of water-miscible organic solvents and aqueous mixtures thereof, at a temperature greater than 30° C., to form a carotenoid solution; and (ii) mixing the carotenoid solution with the aqueous molecular or colloidal solution to form the suspension.

26. The process according to claim 17, wherein providing the suspension comprises: (i) providing an initial aqueous molecular or colloidal solution comprising the at least one protective colloid; (ii) dispersing the one or more carotenoids in the initial solution; and (iii) combining the initial solution with isomalt to form the suspension.

27. The process according to claim 26, wherein the at least one protective colloid comprises a modified starch.

28. The process according to claim 26, wherein the one or more carotenoids comprises a compound selected from the group consisting of β-carotene, lutein, zeaxanthin, lycopene, and mixtures thereof.

29. The process according to claim 27, wherein the one or more carotenoids comprises a compound selected from the group consisting of β-carotene, lutein, zeaxanthin, lycopene, and mixtures thereof.

30. The process according to claim 26, further comprising grinding the one or more carotenoids.

31. The process according to claim 30, wherein grinding the one or more carotenoids is carried out subsequent to combining the initial solution with isomalt.

32. A dry powder prepared by the process according to claim 15.

33. The dry powder according to claim 30, wherein the one or more carotenoids is present in an amount of 0.1 to 40% by weight, based on the dry powder.

34. A dry powder prepared by the process according to claim 22, wherein the compound selected from the group consisting of β-carotene, lutein, zeaxanthin, lycopene, and mixtures thereof is present in an amount of 5 to 25% by weight, based on the dry powder.
